(19) United States
(12) Patent Application Publication
(10) Pub. No.: US 2002/0034963 A1
(43) Pub. Date: Mar. 21, 2002

(54) Intelligent communication gateway device

(76) Inventors: Paul Lansing, Orangeville (CA); Kevin R. Alexander, Cambridge (CA)

Correspondence Address: Bhupinder S. Randhawa, Bereskin & Parr, Box 401, 40 King Street West, Toronto, ON, M5H 3Y2, CA

(21) Appl. No.: 09/931,180

(22) Filed: Aug. 17, 2001

Related U.S. Application Data
(60) Provisional application No. 60/225,785, filed on Aug. 17, 2000.

(51) Int. Cl. H04M 1/00

(52) U.S. Cl. 455/552; 455/17; 455/22

(57) ABSTRACT

The present invention provides a system for dynamically translating between a first communication protocol and a second communication protocol, said system comprising: means for receiving a first communication signal utilizing said first communication protocol; means for determining said first communication protocol; means for initiating a first communication protocol translator to extract data from said first communication signal in accordance with said first communication protocol and for storing said data in a buffer; and means for retrieving said data from said buffer and translating into a second communication stream utilizing said second protocol.

### FIELD OF THE INVENTION

This invention relates to communication systems. More particularly, it relates to communication gateway devices which may be used to couple communication networks which may be operating with incompatible communication protocols.

### BACKGROUND OF THE INVENTION

The number of communication protocols in use for analog and digital telecommunications has increased rapidly in recent years and continues to do so. Various public and proprietary standards have been introduced in order to provide increased functionality for certain tasks, to increase a company's control over the products used by its customers, etc. For example, a number of different and mutually incompatible communication protocols are to be used for data transfer in different computer networks (i.e. Appletalk, Windows network, TCP/IP, UDP, X.10, etc.). The proliferation of standards is not limited to purely digital communications. In North America, video (i.e. television) signals were once transmitted primarily using the NTSC video standard. Recently, however, video is now transmitted over the Internet using the MPEG-3 standard. In addition, programs such as Windows Media Player and Real Player use their own streaming video and audio protocols. In some cases, the use of different protocols requires the use of different physical connectors.

In order to facilitate communications between computer networks which use different communication protocols, it is necessary to provide a mechanism for translating from one protocol to another.

The traditional method for solving this problem, in relation to two disparate computer networks, has been to install a protocol conversion utility into computers on one of the computer networks (“the first network”). The first network utilizes a first communication protocol which is incompatible with a second communication protocol that is used by the second network. The protocol conversion utility generally performs two tasks. First, it intercepts a communication stream originating from the computer on which it is installed and converts the communication stream, which is compatible with a first communication protocol, into a communication stream that is compatible with a second protocol. Second, the protocol conversion utility intercepts a communication (which is compatible with the second protocol) received from the second network and converts it into a communication stream which is compatible with the first protocol, and may therefore be understood by the computer itself. An example of this type of protocol conversion utility is the well known Samba utility, which may be installed on UNIX based computers to allow them to communicate with computers operating under Microsoft Windows.

While this solution allows for communication between two computer networks operating with different communication protocols, it is limited to the context of two networks. If computers on the first network must also communicate with computers on a third network which uses a third communication protocol that is incompatible with both the first and second communication protocols, a second protocol conversion utility must be installed on the computers of the first network. Similarly, a computer on the first network may require the installation of additional protocol conversion utilities to allow communication with other networks using other communication protocols.

The installation and maintenance of these protocol conversion utilities can require the assistance of competent technical support personnel. This is particularly so in the case of computers used in a business enterprise, where a large number of computers may require many different protocol conversion utilities.

Accordingly, there is a need for an intelligent communication gateway capable of facilitating communications between computers on a first computer network and computers on a variety of disparate communication networks which use communication protocols incompatible with that of the first communication protocol. It is preferable that this gateway include a simple method for updating and adding to its communication protocol algorithms.

### SUMMARY OF THE INVENTION

In a first aspect, the present invention provides a system for dynamically translating between a first communication protocol and a second communication protocol, said system comprising: means for receiving a first communication signal utilizing said first communication protocol; means for determining said first communication protocol; means for initiating a first communication protocol translator to extract data from said first communication signal in accordance with said first communication protocol and for storing said data in a buffer; and means for retrieving said data from said buffer and translating into a second communication stream utilizing said second protocol.

### BRIEF DESCRIPTION OF THE DRAWINGS

The present invention will now be explained, by way of example, with reference to the drawings in which:

FIG. 1 is a schematic of a system incorporating an intelligent communication gateway device and a server according to the present invention; and

FIG. 2 is a schematic diagram of the communication gateway device of FIG. 1.

### DETAILED DESCRIPTION OF THE PREFERRED EMBODIMENT

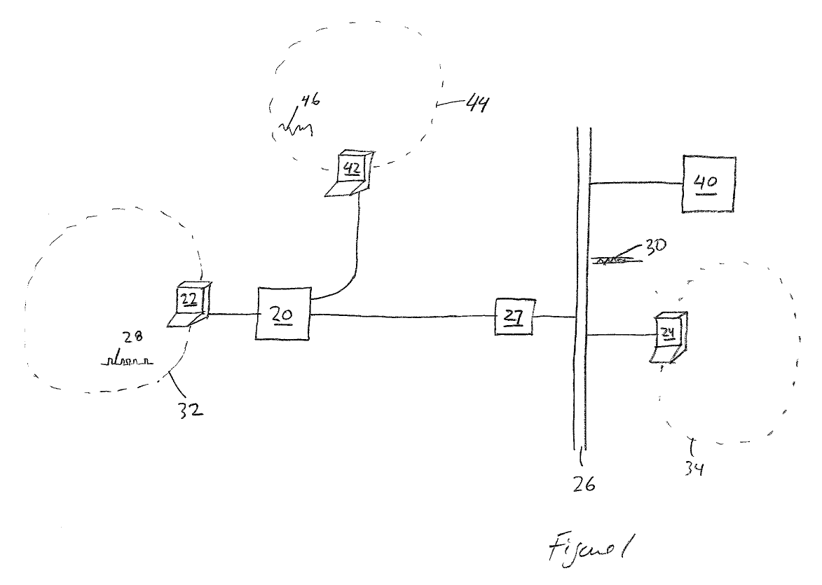

Reference is first made to FIG. 1, which illustrates the use of an intelligent communication gateway device 20 and a server 40 according to the present invention. Device 20 is shown as part of an exemplary system 21, in which it is coupled between a first local computer 22 and a remote computer 24 through a demarcation point 27 and a network 26. Local computer 22 utilizes a first local communication protocol 28 which is incompatible with a remote communication protocol 30 utilized by network 26. Network 26 may be the Internet or another communication network. Local computer 22 may be part of a first local computer network 32, which also utilizes local communication protocol 28. Similarly, remote computer 24 may be part of a remote computer network 34.

Device 20 is also coupled to server 40 through demarcation point 27 and network 26. Alternatively, device 20 may coupled to server 40 through a different network (not shown). Typically, demarcation point 27 is the location at which local computer 22 and any associated devices (such as device 20) under the control of the operator (not shown) of device 20 may be coupled to network 26.

Device 20 also couples first local computer 22 with a second local computer 42, which may be located in the same building or may be operated by the same organization as first local computer 22. Second local computer 42 may be part of a second local computer network 44 which utilizes a second local communication protocol 46.

As an example, first local computer 22 (and first local computer network 32) may use a communication protocol such an the Microsoft Windows Network protocol in conjunction with the well-known Microsoft Window NT™ operating system. Network 26 may use the common TCP/IP communication protocol. Second local computer 42 may use the Appletalk communication protocol used by the Mac OS™ operating system.

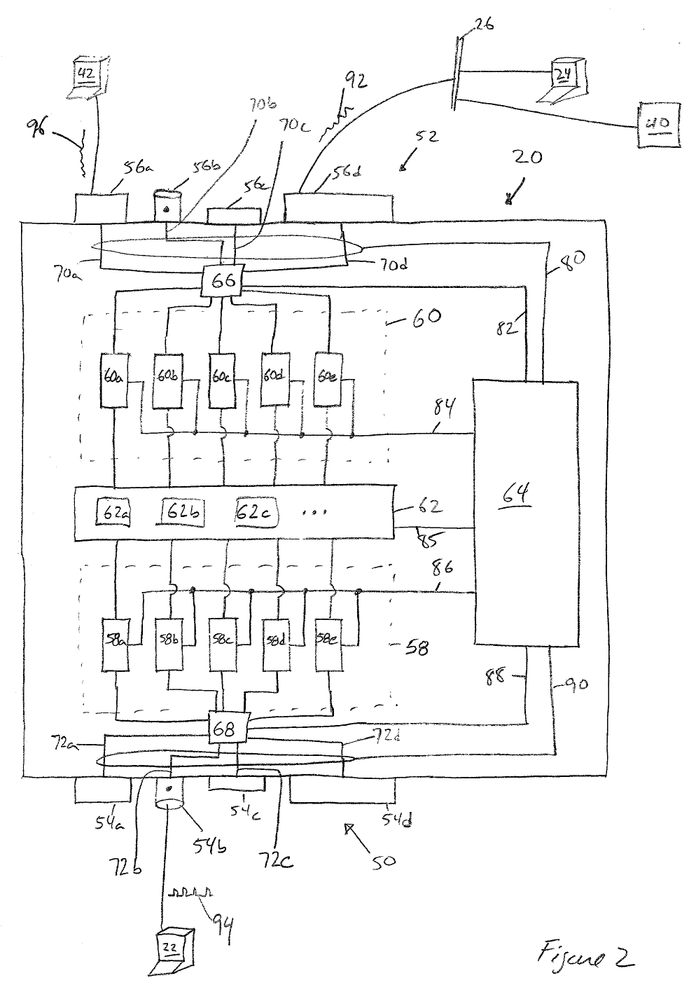

Reference is next made to FIG. 2, which illustrates device 20 in greater detail. Device 20 has a local coupling panel 50, a remote coupling panel 52, a set of local communication protocol translators 58a-58e (collectively 58), a set of remote communication protocol translators 60a-60e (collectively 60), a set of data compatibility protocol buffers 62a-62c (collectively 62) and control module 64.

Local coupling panel 50 comprises a number of local connectors 54a-54d. Remote coupling panel 52 comprises a number of remote connectors 56a-56d. Local connectors 54a-54d may be different types of terminal connectors to which different types of communication cables may be coupled. For example, local connector 54a may be an ethernet 10baseT connector, local connector 54b may be a BNC type connector, local connector 54c may be a standard phone jack and local connector may be a RJ-58 connector. One or more of local connectors 54a-54d may be identical terminal connectors to allow device 20 to be coupled to two or more identical communication lines. In addition, local coupling panel 50 may include more (or less) than four local connectors. Similarly, remote connectors 56a-56d may include one or more different type of terminal connectors and remote coupling panel 52 may have more or less than four remote connectors.

Each remote communication protocol translator 60a-60e is a software module configured to translate a data stream received from any one of remote connector 56a-56d into a common data protocol, which is referred to as a “data compatibility protocol” (DCP). The DCP is defined so that similar data received on communication streams having different communication protocols may be represented in an identical way. For example, a data stream containing a multimedia video and audio signal may be translated into an identical format regardless of whether it is initially received as a Real Player™ data stream or as an NTSC video signal. The DCP therefore includes standard methods of representing a wide variety of data types, including static data such as a text file and streaming data such as a video or audio signal.

Each local communication protocol translator 58a-58e is a software module configured to translate data from the DCP into a specific communication protocol so that it may be transmitted to a computer which utilizes that communication protocol.

Remote communication protocol translators 60 and local communication protocol translator 58 are coupled through DCP buffers 62. Each DCP buffer is a first in-first out buffer.

Remote connectors 56a-56d are coupled within device 20 to switch 66 through connecting lines 70a-70d. Switch 66 is capable of coupling any one of the remote connectors 56a-56d to any remote communication protocol translator 60a-60e. Similarly, local connectors 54a-54d are coupled to switch 68 through connecting lines 72a-72d. Switch 68 is capable of coupling any local connector 54a-54d to any local communication protocol translator 58a-58c.

Control module 64 is a software module that is coupled to: connecting lines 70a-70d through a monitoring line 80; switch 66 through a control line 82; remote communication protocol translators 60 through a communication line 84; DCP buffers 62 through a control line 85; local communication protocol translators 58 through a communication line 86, switch 68 through a control line 88; and connecting lines 72a-72d through a monitoring line 80.

As noted above, communication protocol translators 58 and 60 are software modules. Although they are shown in schematic form in FIG. 2, any particular communication protocol translator 58a-58e or 60a-60e may not exist at any particular time. Control module 64 creates an instance of each communication protocol translator 58a-58e or 60a-60e as required. Every instance of communication protocol translator is able to communicate with control module 64 on one of communication lines 84 or 86.

Similarly, although three DCP buffers 62a-62c are shown in FIG. 2, the number of DCP buffers actually required in device 20 at any particular time may vary and control module 64 may create or destroy DCP buffers as necessary.

Device 20 operates as follows to facilitate communications between remote computer 24, which uses communication protocol 34 and local computer 22 which uses communication protocol 28.

Control module 64 monitors connecting lines 70a-70d at all times through monitoring line 80. When a communication stream 92 is initially received from remote computer 24 at remote connector 56d, control module 64 determines the communication protocol utilized to transmit communication stream 92. Control module 64 then initiates an instance of a remote communication protocol translator 58 which is configured to extract data from communication stream 92. Control module 64 also creates a DCP buffer 62 to receive the extracted data and instructs switch 66 to couple remote connector 56d to newly initiated remote communication protocol translator. Control module 64 also determines the local computer (i.e. local computer 22) that the communication stream 92 is intended for.

Control module 64 is also monitoring connecting lines 72a-72d at all times to determine which lines have been physically connected to a local computer (i.e. local computer 22), and what communication protocol any such local computer utilizes. When control module 64 detects a communication stream (ie. Communication stream 92) which is intended to be sent to a local computer connected to a local connector 54a-54d, control module 64 initiates a local communication protocol translator 58 configured to translate between the DCP and the communication protocol utilized by the local computer. Control module 64 then instructs switch 68 to couple the newly initiated local communication protocol translator to the appropriate local connector 54a-54d.

For example, if communication protocol 30 (FIG. 1) is TCP/IP, then control module 64 will initiate an instance of remote communication protocol translator 60c, which is, for the purpose of this example, configured to extract data from a TCP/IP communication stream. Control module 64 will also instruct switch 66 to couple remote connector 56d to the new instance of remote communication protocol translator 60c. Control module 64 will also create a DCP buffer, in this example DCP buffer 62a and instruct remote communication protocol translator 60c to put any data extracted from communication stream 92 in DCP buffer 62a.

Control module 64 will also initiate a local communication protocol translator 58e which is capable of translating between the DCP and the Windows Network protocol used by local computer 22. Control module 64 will instruct this newly initiated communication protocol translator to extract data from DCP buffer 62a, convert it into an appropriate communication stream 94 and transmit it to local computer 22.

In this way, a communication stream transmitted by remote computer 24 using a communication protocol 30 (FIG. 1) is converted into a communication stream compatible with communication protocol 28 used by local computer 22. The instances of remote communication protocol translator 60c, DCP buffer 62a and local communication protocol translator 58e will stay in place as long as communication stream 90 is received using communication protocol 30.

When a communication stream 96 is received from second local computer 42 using communication protocol 46 (FIG. 1), control module 64 will create additional instances of remote communication protocol translator 60 (i.e. 60a), DCP buffer 62 (i.e. 62b) and local communication protocol translator 58 (i.e. 58 e′) to receive communication stream 96 and convert it into a communication stream suitable for transmission to local computer 94 (i.e. a communication stream compatible for communication protocol 28). This additional local communication protocol translator 58e′, which will be another instance 58e′ (not shown) of local communication protocol translator 58e will co-ordinate with the previously created local communication protocol translator 58e to ensure that data from remote computer 24 and from local computer 42 is delivered to local computer 22 as part of communication stream 94 in an organized, sequential manner.

If the communication protocol used for communication stream 92 changes such that remote communication protocol translator 60c is unable to translate communication stream 92, then remote communication protocol translator 60c will generate a “level one exception”, which is transmitted to control module 64 via communication line 84. This may happen, for example, if remote computer 24 begins to use a different communication protocol or if network 26 is used by a different remote computer (not shown), which uses a different communication protocol.

In response to the level one exception, control module 64 monitors the appropriate connecting line 70 (i.e. connecting line 70d in the present example) to determine if another remote communication protocol translator 60 may be used to translate the new communication protocol of communication stream 92. If so, then the existing remote communication protocol translator 60c is terminated and another remote communication protocol translator (i.e. communication protocol translator 60b) is initiated and is instructed to extract data from communication stream 92 and place it in DCP buffer 62a. Local communication protocol translator 58e continues to operate as before and communication stream 94 to local computer 22 continues. In this manner, local computer 22 may be coupled to a communication stream which uses multiple incompatible communication protocols.

If another remote communication protocol translator 60 capable of translating the new communication protocol of communication stream 92 is not available, then control module 64 generates a level two exception. This level two exception is transmitted from control module 64 to server 40 and includes a description of the new communication protocol and possibly a sample of communication stream 92 containing the new communication protocol. Server 40 then determines if it contains any remote communication protocol translator (not shown) which could be used to translate the new communication protocol of communication stream 90 to DCP. If so, this remote communication protocol translator is transmitted to control module 64, which (i) creates an instance of the new remote communication protocol translator to receive communication stream 92 and translate it into DCP and store it in DCP buffer 62a and (ii) records the new remote communication protocol translator for future use as required.

If server 40 does not contain a remote communication protocol translator suitable for translating the new communication protocol of communication stream 92, then server 40 generates a level three exception which is transmitted to an operator (not shown) of server 40 and to control module 64. Control module 64 reports the level three exception to local computer 22. The level three exception essentially indicates that device 20 is not capable of translating communication stream 92 into a communication stream 94 utilizing protocol 28. The operator of local computer 22 may then elect to receive communication stream 92 in the format in which it was received by device 92 or may elect to ignore it.

In this manner, server 40 provides a dynamic ability to update device 20 when a new remote communication protocol translator is required to translate a new communication protocol into DCP. Recognizing that a local computer may also utilize a new communication protocol, server 40 may also transmit local communication protocol translator which is capable of translating from DCP to the new communication protocol. When a level three exception occurs, the operator of server 40 may produce new remote and local communication protocol translators to address the new communication protocol. In addition, the operator of server 40 may create new remote and local communication protocol translators when he or she learns of new communication protocols. If this is done rapidly enough, a level three exception relating to that new communication protocol may be avoided. Such new remote and local communication protocol translators may be transmitted to device 20 from server 40 when they are created, thereby avoiding even a level two exception.

In addition to the conditions described above, a level two exception may also occur when a communication stream is initially received by device 20 if it does not contain a remote communication protocol translator capable 60 of translating the communication stream. Similarly, a level two exception may also occur if device 20 does not contain a local communication protocol translator 58 capable to translating from DCP to the communication protocol used by a computer newly connected to the local coupling panel 50 (like computer 22).

Device 20, along with server 40, provides a dynamically and remotely updatable system for receiving and translating a variety of communication streams utilizing a variety of communication protocols. The task of updating and maintaining the collection of remote and local communication protocol translators is transferred to server 40 and the operator of server 40 who may be independent of the user of device 20 and may provide new remote and local communication protocol translators. This system has the advantage that it is transparent to the local computer 22 with which it is used, thereby allowing it to be used by less sophisticated users than is required for the prior art.

evice 20 has been described in the context of a unidirection data stream transmitted from remote computer 24 to local computer 22. Since most communication links are bi-directional, device 20 may be configured to create an additional set of a remote communication protocol translator 60, a DCP buffer 62 and a local communication protocol translator to receive a communication stream (not shown) from local computer 22 and transmit a translated communication stream (not shown) to remote computer 24. Alternatively, if remote computer 24 is capable of directly receiving the communication stream transmitted by local computer 22, then it may be directly sent to remote computer 24.

Reference is again made to FIG. 1. In the specific case when network 26 and local computer 22 use the same communication protocol, then device 20 may be configured to simply couple remote connector 56d to local connector 54b (FIG. 2). Alternatively, the method described above may be used to first convert the received communication stream 92 into DCP and the convert it back into an identical communication stream 94.

The use of a two stage translation (from a first communication protocol to DCP and then from DCP to a second communication protocol) reduces the number of communication protocol translators required. For each particular communication protocol, one remote communication protocol translator and one local communication protocol translator are required. Therefore, if device 20 is to handle n communication protocols it must contain a total of 2n communication protocol translators. If a direct communication protocol translator was developed for each pair of communication protocols, then the total number of communication protocol translators required would equal (n-1)+(n-2)+(n-3)+. . .+1. Although this may be feasible for a very small number of protocols, it is not practical for even a modest number. For example, if a device 20 must deal with 10 (i.e. n=10) communication protocols it will require 20 communication protocol translators. If a direct translation system was used, then 55 communication protocol translators would be required. If n=100 (which is not unreasonable, given the number of different types of communication (i.e data, audio, video, telephone, optical, etc.) then a device 20 will require 200 communication protocol translators while a direct translation device will require 5050 communication protocol translators.

As noted above, local coupling panel 50 has a plurality of local connectors 54a-54d. More than one of these local connectors 54a-54d may be used simultaneously by different local computers (or by the same local computer 22). This allows each of the local computers to be coupled to any computer coupled to a remote connector 56a-56d. In this way, each of a number of local computers may be coupled to the same or different remote computers. The present invention thus provides a device 20 which simultaneously allows any computer coupled to the local coupling panel 50 of the device 20 to be coupled to any computer coupled to the remote coupling panel 52. Each coupling between two computers uses a separate DCP buffer 62 and separate instances of a remote communication protocol translator 60 and a local communication protocol translator 58.

Thus far the invention has been described in the context of coupling two or more computers to one another. The invention is equally suitable for coupling any other device capable of being connected to a network with a computer or with another device capable of being connected to a network. For example, an intelligent appliance such as a network enabled clock may be coupled to a network time server using device 20.

Many variations of the present invention are possible. These variations fall within the scope and spirit of this application, which is limited only by the appended claims.

I claim:

1. A system for dynamically translating between a first communication protocol and a second communication protocol, said system comprising:
(a) means for receiving a first communication signal utilizing said first communication protocol;
(b) means for determining said first communication protocol;
(c) means for initiating a first communication protocol translator to extract data from said first communication signal in accordance with said first communication protocol and for storing said data in a buffer; and
(d) means for retrieving said data from said buffer and translating into a second communication stream utilizing said second protocol.
